(19) United States
(12) Patent Application Publication
(10) Pub. No.: US 2004/0055014 A1
(43) Pub. Date: Mar. 18, 2004

(54) System and method for uniform resource name processing

(76) Inventor: Justin Edelson, Crompond, NY (US)

Correspondence Address: KENYON & KENYON, 1500 K STREET, N.W., SUITE 700, WASHINGTON, DC, 20005, US

(21) Appl. No.: 10/245,362

(22) Filed: Sep. 18, 2002

(51) Int. Cl. H04N 7/173

(52) U.S. Cl. 725/110

(57) ABSTRACT

A Uniform Resource Name is processed with at least one additional piece of information to obtain a resource. The resource can be a remotely stored file that can be fetched and activated. The resource can be activated in conjunction with a signal containing audio or video or graphic information related to the resource.

### FIELD OF THE INVENTION

The field of the invention is uniform resource name processing, and in particular processing a Uniform Resource Name with at least one additional piece of information to obtain a resource to which the Uniform Resource Name corresponds.

### BACKGROUND OF THE INVENTION

A resource such as a file or a collection of files (e.g., a graphic, text, a Web page, a software program, etc.) is located on the World Wide Web (“WWW”) using a Uniform Resource Identifier (“URI”) as defined in RFC 1630, Uniform Resource Identifiers in WWW: A Unifying Syntax for the Expression of Names and Addresses of Objects on the Network as used in the World-Wide Web, dated June 1994. A URI directly or indirectly specifies the mechanism that is used to access the resource (e.g., the protocol used to access the resource, such as HyperText Transfer Protocol (“HTTP”), File Transfer Protocol (“FTP”), etc.); a pointer to the specific computer at which the resource is stored (e.g., at sho.com, mtv.com, vh1.com, etc.); and the specific name of the resource (e.g., a file name such as text1.txt, graphic32.jpg, etc.) A client computer can send a request based upon the URI through a network to a server computer that stores the resource, which can then be sent to the client. In this way, the client “fetches” a resource. A resource can also be fetched locally (i.e., from within the client computer) using a URI.

One type of URI is the Uniform Resource Locator (“URL”), defined in RFC 1738, Uniform Resource Locators (URLs), December 1994. A URL includes the specific name of a resource on the WWW. For example, the location of a file describing a television schedule may be specified by a URL as “http://www.sho.com/schedule/whats_on.txt.” This specifies that the HTTP protocol should be used to access the resource, which is located at the computer at www.sho.com, in the “schedule” directory, and is named “whats_on.txt.” While a URL is very precise, if the name, location or protocol of a resource changes, then the URL must be updated to reflect such changes in order to properly locate the resource. This can be problematic for a resource whose protocol, location and/or name changes over time. Also, if a URL is intended to be used for a particular purpose, as is typically the case, and if the resource itself changes, the URL can be at least outdated and useless, and at worst misleading. For example, if an old resource is a file showing the latest changes to a schedule, and a new resource that is meant to replace the old resource is a program designed to update the information already on hand about a schedule, then a URL to the old resource can mislead a user into thinking that she has the latest changes to a schedule, while in fact this information is obsolete. Again, this can be avoided by updating the URL, but this can be difficult or impossible, e.g., when the URL is stored on a user machine that is not accessible (e.g., in a bookmark file) to the entity that has updated the URL.

A different type of URI than the URL is a Uniform Resource Name (“URN”). A URN is a URI that provides a persistent, “independent” name for a resource. For example, the URN can be independent of the resource's location, protocol, type, etc. One scheme for specifying URNs is disclosed in RFC 2141, URN Syntax, May 1997. An example of a URN to a resource that describes a television schedule is urn::schedule://today. This same URN can be used to locate a television schedule for today without having to know where it is located, the particular name of the file, or which protocol must be used to access the file. The URN advantageously need not be updated when the location, name or protocol of the particular resource changes, or even if the resource itself changes. As such, it is much more versatile than a URL.

In summary, as used herein, the term URL refers to a fully specified (e.g., location, protocol, etc.) reference to a resource, while the term URN refers to an independent (at least one parameter unspecified), relatively persistent reference to a resource.

A resource that is related to media information, such as audio and/or visual (“AV”) information, can be provided to a user by embedding a reference to the resource in the audio and/or visual information when it is sent to the user, or else by providing the reference to the user over a separate channel. AV information is also referred to as “a signal containing audio or video information”. Media information is any type of information, including audio, video, graphics, text, animation, etc. Examples of a “related” resource include: animated text of a recipe of a dish that is shown being prepared by a chef in an AV signal, where text showing the name and quantity of each ingredient appears as it is added; real-time results of online voting about a subject shown in a related AV signal, such as voting by online participants about who is winning a boxing match being shown on television; a user-selected, customized soundtrack (e.g., the original score, director's comments, etc.) to a movie being shown in an AV signal; etc. The related resource can be shown in synchrony with the AV signal; that is, all or a certain part of the resource can be shown at about the same time as a predetermined part of the AV signal is rendered. For example, a piece of text showing an ingredient and amount can be shown at about the time the chef is shown adding the ingredient to the recipe. An AV signal or resource is “rendered” when it is made perceptible to a user, e.g., played, shown, displayed, etc.

The reference to a related resource can be a URL, but if the location, name or protocol of the resource changes, the URL will disadvantageously either be outdated and inaccurate, or else have to be updated before being used. If the URL is outdated and inaccurate, then the wrong or no resource will be sent to the user. It can be impractical to update URLs that are references to related AV information, especially when the URLs are entered for distribution manually, or when a URL has already been distributed and locally stored in hundreds or thousands of different computers. For example, a URL can be embedded in an AV signal, and the combination distributed (e.g., downloaded and stored) to thousands of users. One may not have access to this combined signal to change the URLs that need to be updated. This problem is exacerbated when the location, name and/or protocol of the resource change frequently.

### BRIEF DESCRIPTION OF THE DRAWINGS

FIG. 1 shows the system in accordance with an embodiment of the present invention

FIG. 2 shows the method in accordance with an embodiment of the present invention.

### DETAILED DESCRIPTION

In accordance with an embodiment of the present invention, a URN is processed with at least one additional piece of information (called a “parameter”, “attribute”, “data set”, etc.) to obtain a resource to which the URN corresponds. A resource can be “obtained” by identifying and fetching it. For example, a URN can be processed with the date and time at which the processing commences to obtain a URL that points to a specific resource. The URL that results from the processing can be different for the same URL when it is processed on different dates and times.

One application of the URN processing in accordance with an embodiment of the present invention involves interactive media. A URN, rather than a URL, can be sent to a user, where the URN is a reference to a resource that is related to media information. In one embodiment, the URN can be sent to the same receiver as AV information, e.g., to a set top box on a television, or to a computer. In another embodiment, the URN is sent to a different device than the AV information. For example, the AV information is sent to a television via the airwaves (broadcast) or a set top box, while the URN is sent to a computer via a cable modem, over an Ethernet network, over a pager network, etc.

Unlike a URL, which contains specific information regarding the protocol, location, etc. of a resource, a URN is independent of at least one parameter, such as location, protocol, etc. While the URL can contain all of the information needed to obtain the resource to which is refers, the URN can be further processed to obtain the resource, and the specific resource that corresponds to the URN can depend upon the value of one or more parameters. The generality of the URN advantageously permits the location, protocol, etc. of its resource to change, without having to change the URN itself. The method in accordance with an embodiment of the present invention can involve processing the URN in an efficient way that is more advantageous than using a URL, and is discussed in more detail below.

The receiver of the URN can fetch and render (e.g., display, play, etc.) the resource to which the URN refers on the same display as the AV information. For example, both can be displayed on the same television set or computer monitor, e.g., with the AV information shown as a “picture-within-picture” (“PIP”), and the resource displayed on the rest of the screen. Alternatively, the AV information and the resource to which the URN refers can be displayed on separate monitors. For example, the AV information can be displayed on a television set, while the URN resource (the resource to which the URN refers) can be displayed on a computer monitor. The computer monitor and the television set can be in the same room.

The URN and the AV information can be sent over the same channel, such as a radio frequency channel (e.g., a broadcast television channel carrying analog or digital information), over a cable, etc. The URN can be embedded in the Vertical Blanking Interval (“VBI”) of an AV signal, or multiplexed into a stream of digital data carrying AV information. Alternatively, the URN can be sent over a different channel than the AV information. For example, the URN can be sent to a user computer using a conventional modem over telephone lines, or over the lines of a cable television (CATV) system, while the AV information can be sent to the user computer (or a separate device such as a television) over the airwaves.

In summary, a URN that refers to information related to certain AV information can be sent to the same or a different device than the AV information, over the same or one or more different channels than that over which the AV information is sent. URN information can be displayed on the same or one or more different display devices than the AV information. Of course, the “display” of URN information is only one of the many uses that can be made of the present invention. Any resource related to AV,information can be activated in accordance with the present invention. For example, the activation of a URN can add a user's e-mail or regular address to a distribution list; turn on or off a security system; place a telephone call; etc.

In one embodiment of the present invention, a plurality of URNs are sent to a recipient in the form of a “playlist”. The playlist may be an ordered or non-ordered set of URNs to be used in conjunction with certain AV information. In other words, the URNs can be “played” (their resources fetched or otherwise used, which is also referred to as “activating” the resource to which the URN refers) in the order in which the URNs occur in the playlist, or in any other order (e.g., randomly). A URN resource can also be activated when the URN occurs alone, e.g., not in a playlist. Examples of “activating a URN resource” corresponding to a URN include playing the resource, displaying the resource, executing the resource (e.g., when the resource is a software program or part thereof), etc. On the other hand, “activating a URN” itself means fetching the resource to which the URN corresponds.

The playlist can include synchronization information that indicates when a URN resource should be activated and/or when a resource that corresponds to a URN should be fetched, i.e., when the URN resource should be activated and/or when the URN should be activated. This synchronization information can occur as an absolute time, e.g., activate the URN at 3:24:20 PM on Apr. 17, 2002); or relative to an event in the AV information (e.g., activate the URN at the beginning of the second commercial break as indicated in the AV information that is labeled “Isaak_Show_{—}#4590”; activate URN seventeen minutes four seconds after the beginning of the show; activate the URN upon detecting a trigger labeled “URN::commercial://43789” in the AV information; etc.) Alternatively, synchronization behavior can be programmed into software that operates in a set top box adapted to receive and activate URNs that are related to AV information. For example, a “naked” list of URNs can be sent to the set top box, which stores and is adapted to execute a URN activation program that activates the next URN on the list every time the software detects a “URN activation trigger” in a stream of AV information received by the set top box. Examples of URN activation triggers are: “activate the next URN on URN playlist 271563”; “activate the third URN on the current playlist”; “skip (do not activate) the next URN”; etc. Several URN playlists can be stored, each with an associated label that is used to correlate the correct playlist with the correct program, i.e., to ensure that the URNs on the correct playlist are activated in conjunction with a particular program.

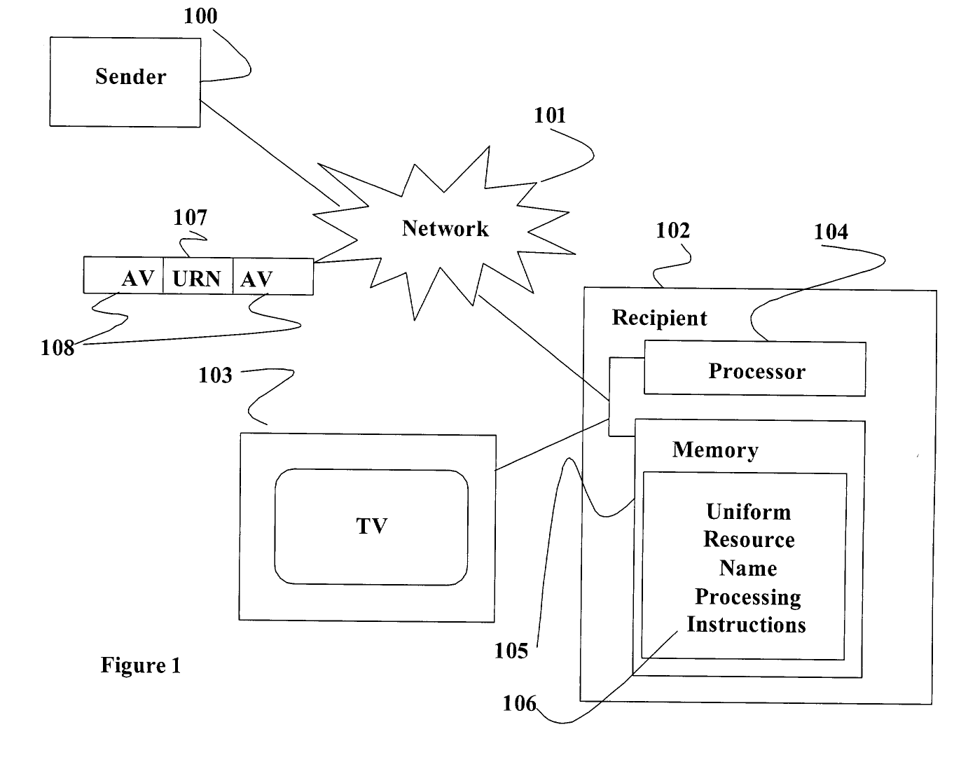

An embodiment of the present invention is shown in FIG. 1. For simplicity, this embodiment distributes URNs over the same channel as AV information. Sender 100 multiplexes URN information with digital AV information, which is distributed over a CATV network 101 to a recipient set top box 102 that is coupled to a television set 103. The set top box includes a processor 104 coupled to a memory 105. Processor 104 can be a general purpose multiprocessor, such as the Pentium IV processor manufactured by the Intel Corporation of Santa Clara, Calif. Processor 104 can also be an Application Specific Integrated Circuit (“ASIC”) that embodies at least a part of the method in accordance with an embodiment of the present invention in hardware and/or firmware. An example of an ASIC is a Digital Signal Processor (“DSP”).

Memory 105 is any device adapted to store digital information, such as Random Access Memory (“RAM”), Read Only Memory (“ROM”), flash memory, a hard disk, a CD-ROM, etc., or any combination thereof.

Memory 105 stores URN processing instructions 106 that are adapted to be executed by processor 104 to perform the method in accordance with an embodiment of the present invention.

In FIG. 1, A URN 107 is embedded in AV information 108 and is sent from sender 100 to set top box 102 over CATV network 101. Processor 104 executes URN processing instructions 106 to receive and process the URNs in conjunction with AV information, such as triggers that are embedded in the AV information. In another embodiment, a URN playlist is stored in memory 105. URNs from the playlist are fetched and processed by processor 103 in accordance with URN instructions 105.

As discussed above, a URN can require more processing than a URL to obtain the resource to which the URN refers. This additional processing is a tradeoff for the additional flexibility in being able to change attributes of the resource (e.g., location, protocol, etc.) without having to change the URN that can be an advantage of using a URN rather than a URL. For example, memory 105 can store a first table that correlates a particular protocol with different URN formats. An example of such a URN protocol table can be:

| URN Component | Protocol |
|---|---|
| urn::commercial: | HTTP |
| urn::download_and_play | FTP |
| urn::e_mail | SMTP |

This URN protocol table specifies that for any URN that conforms to the format “urn::commercial”, the HyperText Transfer Protocol (“HTTP”) should be used to activate the URN. Likewise, the File Transfer Protocol should be used to activate a URN having the format “urn:download-and-play”, and the Simple Mail Transfer Protocol should be used to activate a URN that starts, “urn::e-mail:”.

The URN protocol table shown above can advantageously be updated from a remote location by sending a new version or patch from the sender or some other remote source to the set top box. For example, the “urn::commercial” protocol can be changed in the above table from HTTP to FTP or to any other suitable protocol. Advantageously, no change is required in the URN, which may have been embedded in the AV information months or years before.

Memory 105 can also store a URN location table that provides information on locating a resource, such as a URL, an IP address, a procedure, etc. An example of such a table can be:

| URN Component | Location |
|---|---|
| ten_second | www.adspot.com |
| thirty_second | 123.34.86.250 |
| one_minute | get_location(present_time) |

In other words, ten second commercials are stored on a server located at www.adspot.com; thirty second commercials are stored on a server located at the Internet Protocol address 123.34.86.250; and the location of one minute commercials is obtained by passing the present time to a procedure called “get-location”. In other words, the location of the server from which a one minute commercial can be obtained changes as a function of time. As for the protocol table, the location table can be updated (changed) without having to change anything in the URN. As a result, the same URN can advantageously by directed to an updated location at which the desired resource can be found.

Memory 105 can store a URN-URL naming table that correlates the name component of a URN with the URL of a resource. In one embodiment, URN processing instructions 106 obtain the name of the resource (e.g., a URL) from the URN by performing a DES encryption or decryption operation on the URN name component, using a key that can be unique to a set top box, or a collection (e.g., a domain) of set top boxes. In another embodiment, the resource name is obtained by concatenating a predetermined string to the URN. In yet another embodiment, the resource name is obtained by hashing the URN, or by hashing the rest of the translated URN, e.g., using the MD5 algorithm. Advantageously, the URN processing instructions 106 can be updated by sending a new module from the sender 100, or from some other source. In other words, the same URN can be made to correspond to resources having different names, without having to change the URN at all.

In another embodiment, the URN processing instructions 106 are located outside of set top box 102 and are instead located somewhere accessible via a network, which may or may not be the same network 101 through which the URNs are received or the same network from which the resources named by the URNs are fetched. As with the embodiments described above, one of ordinary skill in the art will appreciate that various methods can be used by the remote URN processing instructions 106 to process the URN. For example, when the URN processing instructions 106 are located remotely from the recipient of the URN, the URN can be “resolved” by passing it to the remote location, which sends back more detailed resource location information based upon the URN. A URN is “resolved” when it is processed to obtain the fully, qualified name of the resource to which it corresponds. In another embodiment, the URN processing instructions 106 can be distributed across several computers at different locations. In other words, a URN can be resolved by sending it to a first processing module on a first computer and receiving a first result; to a second processing module on a second computer and receiving a second result; and combining the first and second results to obtain a third result that is used to fetch a resource. In this sense, the processing is done in “parallel”. Likewise, the processing can be done serially. In other words, the URN can be sent to a first module at a first computer, and the returned first result can be sent to a second module at a second computer (with or without the originally received URN, or part thereof), which can then send back a second result based upon the first result. The second result can be used to obtain the resource. Of course, one or more of the different modules discussed above can be on the same computer or different computers. One of the computers having one or more translation module can be the same computer that received the URN.

The following is an example of URN processing using the above examples of protocol, location and name translation:

The following URN is received at 13:45:10 GMT by a set top box:

urn:://commercial:one_minute/14534

URN processing instructions 106 and the URN protocol translation table establish that the resource to which the URN refers is to be activated using the HyperText Transfer Protocol. URN processing instructions 106 and the URN location table establish that the location of the resource is to be obtained by passing the time at which the URN is received (13:45:10 GMT) to a software routine called get_location. Routine get_location returns the result, “www.mediaserver2.com”. The URN name translation module decrypts the URN name component “14534” using a cryptographic key resident at the set top box, to obtain the resource name “22207”. URN processing instructions then fetch (or cause to be fetched) a one minute commercial at http://www.mediaserver1.com/22207 and cause it to be displayed on television 103. Any or all of these parameters can be advantageously changed and updated by changing the corresponding tables and/or software without having to change the URN.

Another advantage of the present invention is that it can take into account external conditions in processing a URN. For example, factors (also known as “attributes”) such as the present date and time; the presence or absence of software or other than the URN instructions at the set top box; the capabilities and available resources of the set top box (e.g., available memory, processor type and speed, etc.), the condition of the data connection to the set top box (e.g., bandwidth, congestion of the network, etc.); a user profile stored at the set top box; the location of the set top box (e.g., geographically, its situation in the house, etc.); the recent viewing history of one or more users of the set top box; viewing patterns (e.g., the identity/type of shows watched, the time of day at which they are watched, the duration for which they are watched, channel changing (surfing) behavior, etc.); etc. can be taken into account in processing the URN. Storing user profile information at the set top box advantageously avoids privacy issues that can arise when information about users is stored at a central database that is remote from the user. This accommodation of external factors can be implemented in URN processing instructions 106.

For example, the geographic location of the set top box can influence the selection of a location at which a resource that corresponds to a URN can be found. Copies of the resource can be advantageously stored in various servers at different locations all around the country. The URN processing instructions 106 can advantageously select a resource server that is located closest to the set top box to minimize the amount of latency (delay) between the time the request for the resource is made, and the time the resource is obtained from the server at the set top box. This can also minimize telecommunications costs, and make the most efficient use of the telecommunications network to deliver resources that correspond to URNs.

In another example, the location of the resource derived from a URN upon activation of the URN can be based upon a user profile stored at the set top box. The same URN can correspond to a commercial for diapers if the user profile indicates that there is an infant in the household; a cola commercial if the user household includes teenagers; and an automobile commercial if the household is comprised of adults. Likewise, demographic information stored at the set top box can be used to further refine the selection of the resource. For example, a profile that indicates a household comprised of adults having a high aggregate income can be used in conjunction with a URN to obtain a commercial for a luxury automobile, while a profile indicating a household with a more modest aggregate income can be used in conjunction with the same URN to obtain an advertisement for an economy car. This can be done using tables, as described above, with alternative named resources correlated in a table with all or a portion of a URN and various income levels. Alternatively, this can be done algorithmically by URN processing instructions 106. The tables and/or modules in the URN instructions can advantageously be modified and updated from practically any source. In this way, the translation behavior that corresponds to a particular URN can advantageously be modified without having to modify the URN itself.

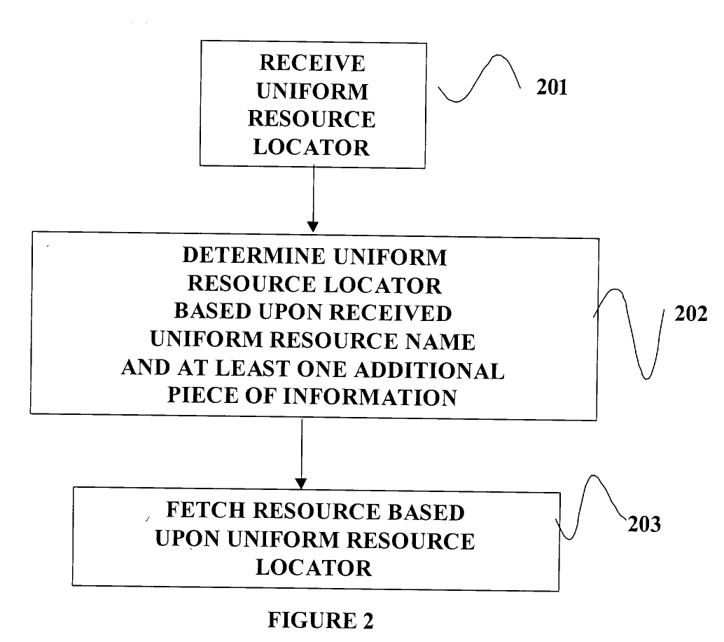

FIG. 2 shows the method in accordance with an embodiment of the present invention. A URN is received, step 201, and processed along with at least one additional piece of information to obtain a URL, step 202. The value of the URL can depend on both the value of the URN and the value(s) of the one or more additional pieces of information. Finally, the resource corresponding to the URL is fetched, step 203.

In accordance with an embodiment of the present invention, software is provided for entering URNs that are related to certain AV information. In one example, URN input software can be implemented at a workstation. The URN input software permits the operator to enter a URN, the time and/or date on which it is to be activated, or an identifier of a trigger in the AV information or elsewhere that, when detected by the set top box, is to trigger the activation of the URN. The input software can also include an interface for building playlists of URNs. For example, the playlist interface can be used by the operator to establish and name a playlist; enter URNs in an ordered or non-ordered (e.g., for round robin activation) fashion; enter the name of AV information to which the playlist corresponds; insert triggers into the AV information; specify times at which the URNs are to be activated; etc. Each playlist can be stored and can be sent to the appropriate computer.

The entered URN information can be stored in any appropriate format, such as a flat file, in a database, etc. If the URN information is to be embedded in the AV information, then a software module in the URN input software can advantageously multiplex the URN into the AV information, e.g., by embedding it the appropriate VBI of the AV information, or by adding into the digital stream of the AV information. The input software can also encrypt the URN, which can advantageously mask the URNs, particularly in compressed AV information, and also make it more difficult to modify the URNs in an unauthorized fashion.

In another embodiment of the present invention, an electronically stored image (e.g., in GIF or JPEG formats) has an image map. The image map that associates a URN with different areas of the image. For example, the image may be divided into quadrants, with each quadrant having a URN. When the user moves his cursor over one of the divisions of the image, the corresponding URN can be activated. For example, the image can be a map of the United States. When the user moves his cursor over the upper left quadrant of the map, a URN map::us.upper.left is activated. The URN is processed with the geographic location of the user, which can be entered by the user, determined automatically from Global Positioning Satellite data, derived from the user's electronically stored profile, etc. If the user is located in that portion of the United States within the upper left quadrant, then weather information is fetched and shown for the Northwest United States. If the user is located outside that portion of the United States (e.g., in Florida), then tourist information for the Pacific Northwest is fetched and displayed to the user. This embodiment shows how URNs can be associated and processed with information spatially in accordance with the present invention.

The foregoing description is meant to provide examples that illustrate various aspects of the present invention, and are not meant to be exhaustive. One of ordinary skill in the art will readily appreciate that there are numerous other features encompassed by the present invention. For example, the activation of a resource using a URN is not limited to the examples given above, but extends to the activation of any resource that can be triggered by the sending of information. For example, the activation of a URN can be made contingent upon some user input (e.g., pressing an “OK” button on a television/set top box remote control), and trigger the purchase of an item online. Also, the invention has been illustrated using embodiments where URNs are used with AV information and graphics. However, the present invention encompasses identifying a resource based upon a URN and at least one additional piece of information in any context.

What is claimed is:

1. A method comprising:
receiving a Uniform Resource Name; and
determining a Uniform Resource Locator based upon the Uniform Resource Name and at least one additional piece of information.

2. The method of claim 1, further comprising fetching a resource based upon the Uniform Resource Locator, wherein the resource is related to the contents of a signal containing audio or video information.

3. The method of claim 1, further comprising activating the resource at approximately the same time as a predetermined part of a signal containing audio or video information is rendered.

4. The method of claim 1, wherein a signal containing audio or video information includes a vertical blanking interval, and further comprising receiving the Uniform Resource Name embedded in the vertical blanking interval.

5. The method of claim 1, further including receiving the signal over a first telecommunications channel and receiving the Uniform Resource Name over a second telecommunications channel that is different from the first telecommunications channel.

6. The method of claim 1, wherein the Uniform Resource Name is received in a playlist.

7. The method of claim 1, wherein the resource is rendered on a first display device and a signal containing audio or video information is rendered on a second display device, wherein the resource and the audio or video signal are related.

8. The method of claim 1, wherein the resource and a signal containing audio or video information are rendered on the same display device, and wherein the resource is related to the audio or video signal.

9. The method of claim 1, wherein the Uniform Resource Name is received on a first computer, and further comprising sending a message based upon the Uniform Resource Name to a second computer that is different than the first computer, and wherein determining a Uniform Resource Locator based upon the Uniform Resource Name is performed on the second computer.

10. The method of claim 1, wherein the at least one additional piece of information includes the date or time.

11. The method of claim 1, wherein the at least one additional piece of information includes an attribute of the recipient of the Uniform Resource Name.

12. The method of claim 11, wherein the attribute of the recipient includes a geographical location of the recipient.

13. The method of claim 11, wherein the attribute of the recipient includes profile information corresponding to the recipient.

14. The method of claim 11, wherein the attribute of the recipient includes privacy information corresponding to the recipient.

15. The method of claim 11, wherein the attribute of the recipient includes an aspect of the hardware corresponding to the recipient.

16. An apparatus, comprising:
a processor;
a memory coupled to said processor, said memory storing Uniform Resource Name processing instructions adapted to be executed by said processor to perform a method including receiving a Uniform Resource Name and determining an action based upon the Uniform Resource Name and at least one additional piece of information.

17. The apparatus of claim 16, wherein the instructions are further adapted to be executed by said processor to perform the action.

18. The apparatus of claim 16, wherein the action includes fetching a resource from a remote location.

19. The apparatus of claim 18, wherein the action includes rendering the resource at approximately the same time as a predetermined part of a media signal is rendered.

20. The apparatus of claim 18, wherein said memory stores an identifier and at least one additional piece of information includes the identifier.

21. The apparatus of claim 20, wherein said identifier substantially uniquely identifies an instance of said apparatus.

22. The apparatus of claim 20, wherein said identifier identifies a type of said apparatus.

23. The apparatus of claim 20, wherein said memory stores additional software and the identifier identifies a version of said software.

24. A computer readable medium storing instructions adapted to be executed by said processor to perform a method comprising:
receiving a Uniform Resource Name; and
determining an action based upon the Uniform Resource Name and at least one additional piece of information.

25. The medium of claim 24, wherein said instructions are further adapted to perform said action.

26. The medium of claim 25, wherein said instructions are further adapted to perform said action at approximately the same time as a predetermined portion of a media signal is rendered.

27. A system, comprising:
means for receiving a Uniform Resource Number; and
means for determining an action based upon said Uniform Resource Number and at least one additional piece of information.

28. The system of claim 27, further comprising means for performing said action.

29. The system of claim 27, further comprising means for performing said action at approximately the same time at which a predetermined portion of a media signal is rendered.
